(19) United States
(12) Patent Application Publication
(10) Pub. No.: US 2011/0246876 A1
(43) Pub. Date: Oct. 6, 2011

(54) PRECISE MEASUREMENT ON A MOBILE COMPUTING DEVICE

(76) Inventors: Sailesh Chutani, Redmond, WA (US); David M. Zar, Maryland Heights, MO (US); Nikhil J. George, Redmond, WA (US)

(21) Appl. No.: 12/952,099

(22) Filed: Nov. 22, 2010

Related U.S. Application Data
(60) Provisional application No. 61/400,709, filed on Aug. 2, 2010.
(60) Provisional application No. 61/341,734, filed on Apr. 5, 2010.

(51) Int. Cl. G06F 3/048; G06F 3/041

(52) U.S. Cl. 715/702; 715/835; 715/823; 715/769

(57) ABSTRACT

In an embodiment, precise measurement on a mobile computing device is facilitated with a computer comprising one or more processors; a computer readable storage medium comprising a sequence of instructions, which when executed by the one or more processors, cause the one or more processors to perform displaying, in a touch-sensitive computer display unit: an image of an object; over the image, a first reticle at a first position and a second reticle at a second position that is spaced apart from the first position; a measurement value representing a linear distance between the first reticle and the second reticle with reference to the object; one or more fine positioning icons each associated with a different direction; obtaining a selection of one of the first reticle and the second reticle as a selected reticle; obtaining user input selecting one of the fine positioning icons; in response to the user input, re-displaying the selected reticle in a new position in a particular direction associated with the selected one of the fine positioning icons.

### CROSS-REFERENCE TO RELATED APPLICATIONS

### BENEFIT CLAIM

This application claims the benefit under 35 U.S.C. §119(e) of provisional application 61/400,709, filed Aug. 2, 2010, and provisional application 61/341,734, filed Apr. 5, 2010, the entire contents of which are hereby incorporated by reference as if fully set forth herein.

### TECHNICAL FIELD

The present disclosure generally relates to performing precise measurements of objects that are shown in images in small display screens. The disclosure relates more specifically to performing precise measurements of objects using mobile computing devices.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

The advent of medical diagnostic devices has changed the manner in which medical personnel collect and evaluate patient data. Medical diagnostic devices include biometric sensors such as ultrasound probes which can collect patient data for visualizing subcutaneous body structures including tendons, muscles, joints, vessels and internal organs for possible pathology or lesions. For example, obstetric sonography, which is commonly used during pregnancy may be used to visualize a fetus.

Traditionally medical diagnostic devices have been large in size and stationed in particular rooms within a hospital setting. Recently, portable medical diagnosis devices have been developed for collecting data from patients in their homes, medical offices, or other suitable locations. The portable medical diagnosis devices are generally lower in costs and are more accessible for patients. However, typically such portable devices feature relatively small display screens. Operators may wish to measure the size of anatomical structures or other objects displayed in the display screens but measurements may be difficult when image sizes or display screen sizes are small.

### BRIEF DESCRIPTION OF THE DRAWINGS

In the drawings:

FIG. 1A illustrates a computer system in accordance with an embodiment;

FIG. 1B illustrates an example of data sampling logic;

FIG. 2 illustrates sampling patient data;

FIG. 3 illustrates ultrasound probe 300 as an example of a biometric sensor 102.

FIG. 4 and FIG. 5 illustrate examples of one or more computers upon which one or more embodiments may be implemented;

FIG. 6 illustrates an embodiment of measurement logic;

FIG. 7 illustrates a screen display of a mobile computing device that is configured to enable initiating performing precise measurements of objects shown in an image;

FIG. 8 further illustrates a screen display of a mobile computing device that is configured to enable initiating performing precise measurements of objects shown in an image;

FIG. 9 and FIG. 10 illustrate modified screen displays;

FIG. 11 illustrates a computer screen display configured with controls to permit adjustment of GCID parameters;

FIG. 12A, FIG. 12B illustrates processes of precise measurement.

### DETAILED DESCRIPTION OF ONE OR MORE EXAMPLE EMBODIMENTS

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### General Overview

In an embodiment, a computer comprises one or more processors; a computer readable storage medium comprising a sequence of instructions, which when executed by the one or more processors, cause the one or more processors to perform displaying, in a touch-sensitive computer display unit: an image of an object; over the image, a first reticle at a first position and a second reticle at a second position that is spaced apart from the first position; a measurement value representing a linear distance between the first reticle and the second reticle with reference to the object; one or more fine positioning icons each associated with a different direction; obtaining a selection of one of the first reticle and the second reticle as a selected reticle; obtaining user input selecting one of the fine positioning icons; in response to the user input, re-displaying the selected reticle in a new position in a particular direction associated with the selected one of the fine positioning icons.

In an embodiment the instructions that cause obtaining a selection of the first reticle or the second reticle as a selected reticle comprise instructions that cause determining, based on stored default reticle values and without user input, the first reticle as the selected reticle by default.

In an embodiment the computer further comprises instructions that cause obtaining user input associated with contact with the display unit at a particular touch position, determining a linear distance from the particular touch position to the first reticle and the second reticle, determining that the particular touch position is closer to the first reticle than the second reticle, and in response, selecting the first reticle as the selected reticle.

In an embodiment the computer further comprises instructions which when executed cause obtaining user input associated with contact with the display unit at a particular touch position; determining a linear distance from the particular touch position to the first reticle and the second reticle; determining that the particular touch position is closer to the first reticle than the second reticle and in response, selecting the first reticle as the selected reticle; obtaining user input associated with a gesture on the display unit after the contact and determining a gesture distance and gesture direction of the gesture; in response to the gesture, re-displaying the selected reticle in a new position in a particular direction corresponding to the gesture distance and gesture direction. In one embodiment the gesture comprises dragging.

In an embodiment, the computer further comprises instructions which when executed cause updating and redisplaying the measurement value corresponding to a new distance between the new position of the selected reticle and a non-selected one of the first reticle and the second reticle.

In an embodiment, the computer further comprises instructions which when executed cause obtaining user input associated with touching and holding one of the fine positioning icons; in response to the user input, re-displaying the selected reticle in a new position that is translated in a particular direction associated with the selected one of the fine positioning icons that is held; repeating the re-displaying until determining that the holding ends.

In an embodiment, the computer further comprises instructions which when executed cause obtaining user input associated with tapping one of the fine positioning icons; in response to the user input, re-displaying the selected reticle in a new position that is translated by one pixel in a particular direction associated with the selected one of the fine positioning icons that is held.

In an embodiment, the computer further comprises instructions which when executed cause re-displaying the selected reticle in a first color and re-displaying a non-selected one of the first reticle and the second reticle in a second color that is different than the first color.

In an embodiment, the computer further comprises instructions which when executed cause displaying the one or more fine positioning icons only in response to obtaining user input selecting an image manipulation function. In an embodiment, one or more of the first reticle and the second reticle is a crosshair. In an embodiment, the computer is a handheld computer coupled to a biometric sensor.

In an embodiment, the computer further comprises instructions which when executed cause storing, in association with the image, position values associated with positions of the first reticle and the second reticle.

In an embodiment, the first reticle and second reticle are associated with any of: endpoints of the measurement line; a diameter of a circle; vertices of a polygon; or loci of an oval or ellipse. In embodiment, the image is an ultrasound scan image.

In other aspects, the disclosure encompasses a method performed by a computer and including one or more of the steps described herein.

Certain embodiments are described herein with reference to positioning a first reticle and a second reticle that are joined by a measurement line. Another embodiment may be used for positioning a single point on an image in a precise manner. In such an embodiment, a computer comprises one or more processors; a computer readable storage medium comprising a sequence of instructions, which when executed by the one or more processors, cause the one or more processors to perform displaying, in a touch-sensitive computer display unit: an image of an object; over the image, a first reticle at a first position and one or more fine positioning icons each associated with a different direction; obtaining user input selecting one of the fine positioning icons; in response to the user input, re-displaying the first reticle in a new position in a particular direction associated with the selected one of the fine positioning icons.

### Structural Overview

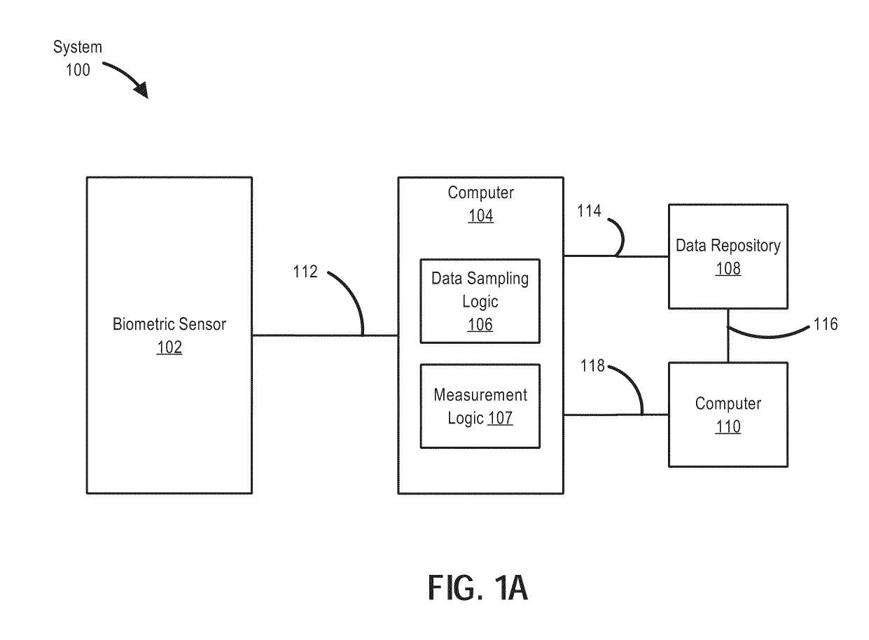

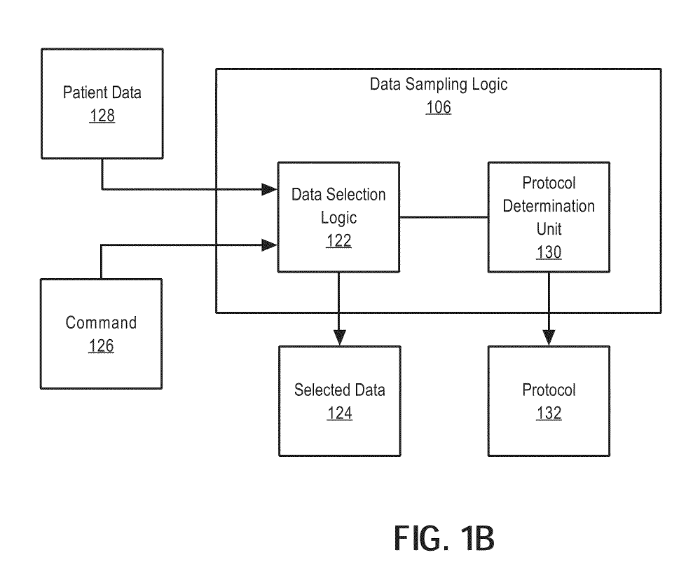

FIG. 1A illustrates a system in accordance with an embodiment. Although a specific system is described, other embodiments are applicable to any system that can be used to perform the functionality described herein. FIG. 1A illustrates a hypothetical system 100. Components of the system 100 may be connected by, without limitation, a network such as a Local Area Network (LAN), Wide Area Network (WAN), the Internet, Intranet, Extranet, satellite or wireless links, etc. Alternatively or additionally, any number of devices connected within the network may also be directly connected to each other through wired or wireless communication segments. One or more components described within system 100 may be combined together in a single device.

In an embodiment, the system 100 includes one or more biometric sensors (e.g., biometric sensor 102), two or more computers (e.g., computer 104 and computer 108), and one or more data repositories (e.g., data repository 108).

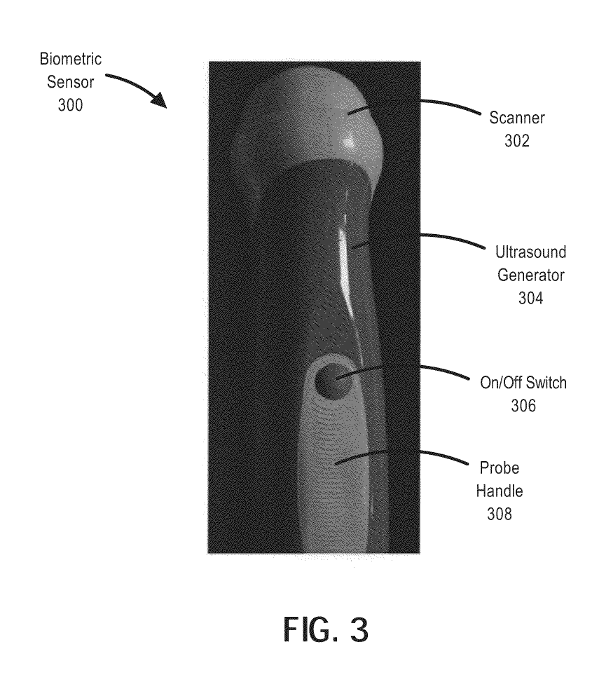

In an embodiment, the biometric sensor 102 generally represents any sensor which may be used to collect data related to a patient, which may be referred to herein as patient data. Patient data may include, without limitation, raw data collected from a patient, an analysis of the patient data, textual information based on raw data, or images based on the raw data. The biometric sensor 102 may collect patient data, for example, while being within a particular range from the patient, while being in direct contact with the patient, or while being applied to the patient through a conductive medium (e.g., gel). A biometric sensor 102 may refer to, for example, an ultrasound probe which collects patient data through sound waves (e.g., with a frequency of 3.5 MHz, 5 MHz, 7.5 MHz, 12 MHz, etc.). FIG. 3 illustrates ultrasound probe 300 as an example of a biometric sensor 102. An ultrasound probe may include a mechanical sector scanner with an ultrasound generator to generate sound waves that are applied toward a patient through a gel or other conductive medium. An ultrasound probe may further include a receiver for capturing sound wave echoes which are used to visualize subcutaneous body structures (e.g., tendons, muscles, joints, vessels, internal organs, fetuses in pregnant women). A biometric sensor 102 may be a handheld device which is operated by an operator (e.g., human or robotic operator). Other examples of biometric sensors include, without limitation, medical cameras, electrocardiogram sensors, pulse oxymeters, and blood glucose monitors.

In an embodiment, the biometric sensor 102 may be used to collect patient data based on a protocol. A protocol generally represents directions for any procedure performed by an operator of the biometric sensor 102. A protocol may define organs that are to be probed and/or measured, actions that are to be performed by an operator, biometric sensor settings (e.g., gain control, intensity, contrast, depth, etc.), locations on a patient where the biometric sensor 102 is to be placed, etc. In an embodiment, each protocol may correspond to one or more exams. For example, a protocol may define a particular procedure to test for symptoms or indications related to a particular disease or other medical diagnosis. Furthermore, protocols may differ based on the patient. For example, thin patients may require a different protocol than obese patients in order to obtain useful patient data.

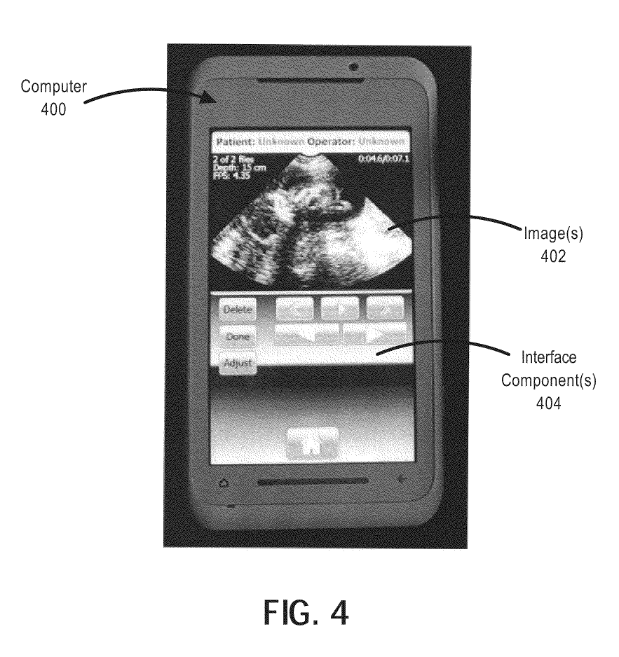

In an embodiment, computer 104 generally represents any device that includes a processor and is communicatively coupled with the biometric sensor 102. Examples of computer 104 include, without limitation, a desktop, a laptop, a tablet, a cellular phone, a smart phone, a pda, a kiosk, etc. Computer 104 may be communicatively coupled with the biometric sensor 102 with wired and/or wireless segments. Computer 104 may be connected directly with the biometric sensor 102 using a universal serial bus (USB) cable. Computer 104 may include functionality for determining or receiving one or more protocols for use with the biometric sensor 102 to collect patient data. In an embodiment, computer 104 includes a data sampling logic 106 and measurement logic 107, which may comprise firmware, hardware, software, or a combination thereof in various embodiments that can implement the functions described herein. FIG. 4 illustrates a computer 400, as an example of computer 104, which may be used with an ultrasound probe or other biometric sensor 102.

In an embodiment, computer 104 may include one or more buffers for recording patient data. For example, computer 104 may include images based on the patient data collected by the biometric sensor 102. Patient data recorded in any buffer within computer 104 may be sampled at varying rates (e.g., varying number of samples per second) and using varying techniques. For example, every other image within a buffer may be sampled and transmitted to another computer (e.g., computer 110). In another example, every other horizontal vector or vertical vector from each image may be sampled and transmitted. A portion of interest of each image may be selected and transmitted. Different buffers within computer 104 may record the similar patient data with varying levels of detail. For example, a particular buffer may include all patient data and another buffer may include a portion (e.g., based on sampling rate) of the patient data. In an embodiment, a buffer may be configured to store patient data corresponding to a window of time. For example, a buffer may be continuously update to store newly-collected patient data while deleting at least a portion of previously-collected patient data from the buffer. A buffer may include patient data collected, for example, within the last ten minutes a current time. Patient data stored within a buffer at a particular time may be stored in a different location to avoid deletion or may be transmitted to a remote system.

In an embodiment, computer 110 may include one or more components and/or one or more functionalities described herein in relation to computer 104. Computer 110 may be located remotely from biometric sensor 102 and computer 104. Computer 110 may obtain data collected by the biometric sensor 108 directly from the biometric sensor 108 or via computer 104. Computer 110 may be operated by a remote user to provide instructions which are transmitted to computer 104. For example, computer 110 may be configured to determine or receive one or more protocols for operating the biometric sensor 108 and transmit the one or more protocols to computer 104.

In an embodiment, the data repository 108 generally represents any data storage device (e.g., local memory on computer 104, local memory on computer 110, shared memory, multiple servers connected over the internet, systems within a local area network, a memory on a mobile device, etc.) known in the art which may be configured to store data. In one or more embodiments of the invention, access to the data repository 108 may be restricted and/or secured. As such, access to the data repository 108 may require authentication using passwords, secret questions, personal identification numbers (PINs), and/or any other suitable authentication mechanism. Those skilled in the art will appreciate that elements or various portions of data stored in the data repository 108 may be distributed and stored in multiple data repositories (e.g., servers across the world). In one or more embodiments of the invention, the data repository 108 includes flat, hierarchical, network based, relational, dimensional, object modeled, or data files structured otherwise. For example, data repository 108 may be maintained as a table of an SQL database. In addition, data in the data repository 108 may be verified against data stored in other repositories.

### Architectural and Functional Overview

FIG. 1B illustrates an example of a data sampling logic 106. In an embodiment, the data sampling logic 106 comprises a data selection logic 122 and a protocol determination unit 130. One or more components of the data sampling logic 106 may be located on a different computer (e.g., computer 110) that is communicatively coupled with computer 104.

In an embodiment, the data selection logic 122 includes functionality to select data 124 from patient data 128 that is collected by one or more biometric sensors. The data selection logic 122 may select a portion of available patient data 128 or all of available patient data 128. The data selection logic may obtain a sample of the patient data 128 according to a particular sampling rate. For example, if the patient data 128 includes a set of images collected over time, then the data selection logic 122 may select a subset of the images that were collected every n^{th} second. The data selection logic 122 may be configured to sample a portion of data collected at a particular time. For example, if a portion of data collected at time x is presented as an image, the data selection logic 122 may select a portion of that image. The selected portion may include alternate horizontal sections or alternate vertical sections of the image. The selected portion may include an area of interest within the data (e.g., top right region of an image, region of image that is associated with particular body organ, etc.). The data selection logic may include functionality to compare patient data to one or more symptoms related to a medical diagnosis and select a portion of the patient data that matches the one or more symptoms. The data selection logic 122 may select different portions of data collected over time. For example, the data selection logic 122 may select portions of data which identify the progress of a spreading disease. In an embodiment, the data selection logic 122 include functionality to compress patient data. The data selection logic 122 may compress patient data using lossy compression techniques or lossless compression techniques. The compressed patient data may be referred to herein as the selected data 124.

In an embodiment, the data selection logic 122 may select data 124 from patient data 128 based on a command 126. A command 126 may refer to any instructions received from a remote computer (e.g., computer 110). In an embodiment, the command may specifically identify a portion of the patient data 128 that is to be selected. For example, the command 126 may identify a body organ for selection of data related to that body organ. The command 126 may indicate an image resolution or other data quality characteristic. In an embodiment, the command may identify a protocol for obtaining the selected data 124. For example, the command may indicate device settings or an action to be performed by a user with an ultrasound probe which would result in obtaining the selected data 124.

In an embodiment, the protocol determination unit 130 includes functionality for determining (includes selecting) one or more protocols (e.g., protocol 132) for collecting patient data with the biometric sensor 102. As described above, a protocol generally represents any directions for a procedure performed by a human or machine operator of the biometric sensor 102 for collecting patient data via the biometric sensor 102. In an embodiment, the protocol determination unit 130 may determine the protocol 132 based on the command 126. For example, if the command 126 identifies patient data that is not yet collected, the protocol determination unit 130 may determine a procedure for collecting the identified patient data. In an embodiment, the protocol determination unit 130 may select a protocol from a database that is identified by the command 126.

All components of the data sampling logic 106 may be integrated into a single unit of software, firmware, or a combination. Thus, the separate blocks shown in FIG. 1B are provided solely to illustrate one example.

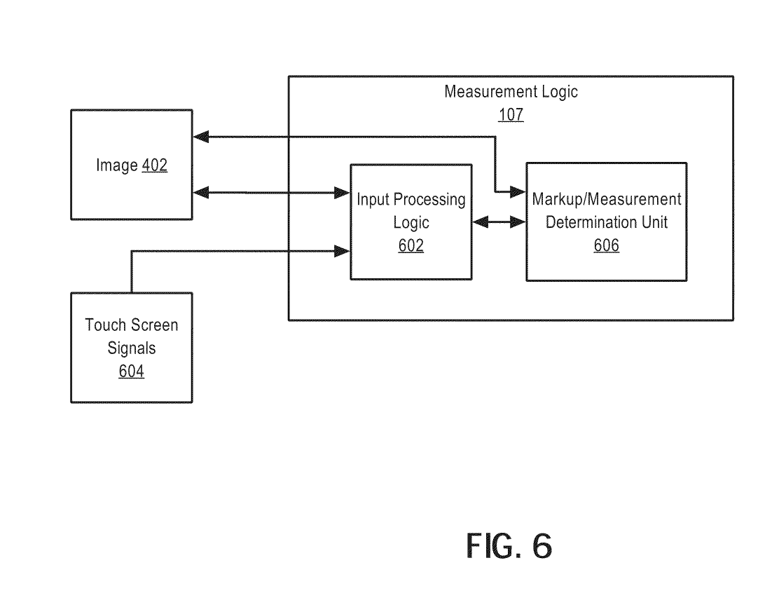

FIG. 6 illustrates an embodiment of measurement logic 107. In an embodiment, measurement logic 107 comprises input processing logic 602 coupled to markup/measurement determination unit 606. Both input processing logic 602 and determination unit 606 are coupled to image 402 in memory of computer 400. Input processing logic 602 is coupled to touch screen signals 604 that computer 400 generates as a result of user interaction with interface components 404. In an embodiment, user interaction with interface components 404 may involve selecting one or more reticles that are displayed on image 402, positioning the one or more reticles, and optionally obtaining measurements of objects or regions of the image, in the manner further described herein.

In general, input processing logic 602 is configured to receive an image, receive touch screen signals, and determine what user requests or commands are represented in the touch screen signals. Touch screen signals 604 may comprise selecting buttons, holding down buttons, selecting items of the image 402, dragging on the image 402, or other gestures or selections. Markup/measurement determination unit 606 is configured generate data representing one or more reticles, lines, or other graphical objects, apply the graphical objects to the image, cause re-displaying the image with graphical objects in the image, optionally compute measurements of lines between reticles or other graphical objects, optionally display measurement data, and cause storing updated images and/or metadata for the images that represents the one or more reticles, graphical objects, and measurement data.

### Data Sampling Procedure

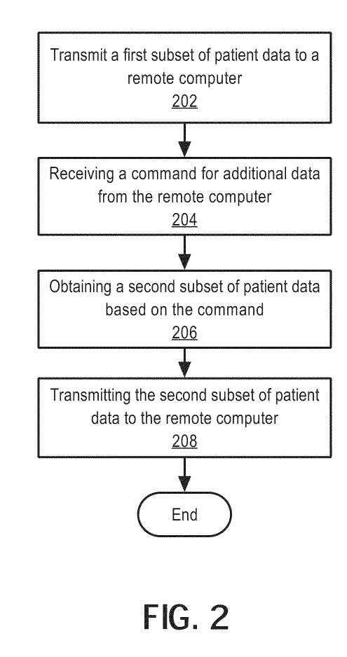

FIG. 2 illustrates an example of data sampling. In an embodiment, one or more of the steps described below may be omitted, repeated, or performed in a different order. The specific arrangement shown in FIG. 2 is not required.

In Step 202, a first subset of patient data is transmitted to a remote computer. In an embodiment, patient data may be stored in a buffer as the patient data is being collected. The patient data being collected may be sampled to obtain the first subset of patient data for transmission. Transmitting the first subset of patient data may include streaming the first subset of the patient data as the patient data is being collected.

In an embodiment, transmitting the first subset of patient data includes transmitting information associated with the first subset of the patient data. For example, information related to how the first subset of patient data was obtained, difficulties involved in obtaining the first subset of patient data, trends associated with the first subset of patient data. The information may include patient information that is relevant to the first subset of patient data. For example, the information may include the patient's weight, blood pressure, cholesterol levels, etc. Transmitting the first subset of patient data may include transmitting a list of options related to the first subset of patient data. For example, if the patient data is indicative of two possible diseases, the first subset of patient data may be transmitted with options for requesting additional patient data related to the two possible diseases.

In an embodiment, the first subset of patient data may be related to internal organs. For example, the first subset of patient data may be obtained by an ultrasound probe and may indicate a visualization of one or more internal organs. The first subset of patient data may be transmitted with a picture of a patient that was taken during the same patient visit as when the first subset of patient data was collected. The picture may be of an area on the patient's body around which one or more biometric sensors were placed for collecting the patient data. In an embodiment, a video of a medical examination in which the patient data is being collected may be transmitted concurrently with the patient data.

In Step 204, a command for additional data is received, from the remote computer, based on the first subset of patient data. The command may request a second version of the first subset of patient data with greater detail. For example, the command may request a set of high resolution images corresponding to low resolution images in the first subset of patient data. The command may request a sample of patient data based on a higher sampling rate than the sample included in the first subset of patient data. In an embodiment, the command may include a modification of the protocol used to obtain the first subset of patient data. For example, the command may include instructions on obtaining data, for a particular organ, that was not included in the first subset of patient data. The command may provide instructions for handling a biometric sensor (e.g., direction of movement, speed, acceleration, etc.) The command may be related to a device setting for one or more biometric sensors being used for collecting patient data. For example, the command may list biometric sensor attachments, display resolution, sampling rate, gain value, intensity value, contrast value, or depth value.

In an embodiment, the received command may be based on an evaluation of the first subset of the patient data. For example, an evaluation of the first subset of patient data may be used to identify one or more symptoms of a particular medical diagnosis (e.g., a disease, a condition, etc.). Based on the identification of one or more symptoms, the received command may include instructions to test a patient for that particular medical diagnosis. In an embodiment, the first subset of patient data may be evaluated for accuracy, completeness, and/or quality. Based on the evaluation of the first subset of patient data, the received command may include instructions for collecting the patient data again. For example, a command to collect the patient data again may be received based on a determination that the patient data does not include all needed information. This determination is based on a sample of the patient data, e.g., the first subset of the patient data. In an embodiment, a command may select data stored in a buffer when the command is received.

In Step 206, a second subset of patient data is identified, for transmission to a remote computer, based on the command. In an embodiment, identification of the second subset of patient data may involve identifying already obtained data that is selected by the command. For example, based on a command which selects a particular organ, all patient data related to that particular organ may be identified. In another example, based on a command which selects current data, all patient data stored in a buffer at the time the command is received is identified for transmission.

In an embodiment, identifying the second subset of the patient data may involve sampling the already obtained patient data at a different sampling rate than the first subset of the patient data. For example, the first subset of patient data, which be a sample of the patient data at a low sampling rate, may be evaluated to deduce that the patient data as a whole is suitable for a medical diagnosis. Based on this deduction, the command may request all of the patient data which was sampled to obtain the first subset of the patient data. In another example, based on the deduction, the command may request a second subset of the patient data at a higher sampling rate than a sampling rate used for obtaining the first subset of the patient data.

In an embodiment, identifying the second subset of the patient data may involve collecting the second subset of the patient data based on instructions received in the command. The second subset of the patient data may be collected from the patient during the same medical examination session. A same medical examination session may refer to the same visit between the patient and the human or machine operator of the one or more biometric sensors. For example, if the command indicates that the patient data must be collected again, identifying the second subset of the patient data may involve collecting additional patient data. If a command indicates a protocol for collecting patient data, the second subset of the patient data may be collected based on that protocol. If a command requests data, a protocol may be determined based on the command to collect the requested data. In an embodiment, identifying the second subset of patient data may involve sampling the collected patient data.

In Step 208, the second subset of patient data is transmitted to the remote computer. Transmitting the second subset of patient data to the remote computer may involve similar steps as transmitting the first subset of the remote computer, as described above.

### Data Sampling Example

In one particular example, which should not be construed to limit the scope described herein, an ultrasound probe is used by an operator to collect patient data from a patient. Newly-collected patient data is stored in a buffer at a local computer as previously-collected patient data is deleted from the computer. The buffer maintains patient data collected within a window of time from a current time to a previous time. In addition, low resolution ultrasound images are generated from the patient data and streamed in real-time to a remote computer system. The remote computer system displays the low resolution ultrasound images as they are received. A remote viewer at the remote computer system then evaluates the low resolution ultrasound images to determine whether the low resolution ultrasound images are appropriate, whether the low resolution ultrasound images focus on the right body part, and/or whether a position of the ultrasound probe needs to be changed. Being satisfied with the low resolution ultrasound images, the remote viewer then submits data or voice input at the remote computer indicating approval. The local computer receives a command from the remote computer based on the remote viewer's input indicating approval. As soon as the local computer receives the command, the local computer stops updating the buffer or deleting any content from the buffer. The local computer then sends high resolution ultrasound images generated from the patient data stored in the buffer. The buffer at the local computer may store high resolution ultrasound images based on raw patient data, instead of or in addition to the raw patient data itself. The high resolution ultrasound images may be sampled to generate the low resolution ultrasound images that were initially sent to the remote computer.

### Precise Measurements of Regions in Images

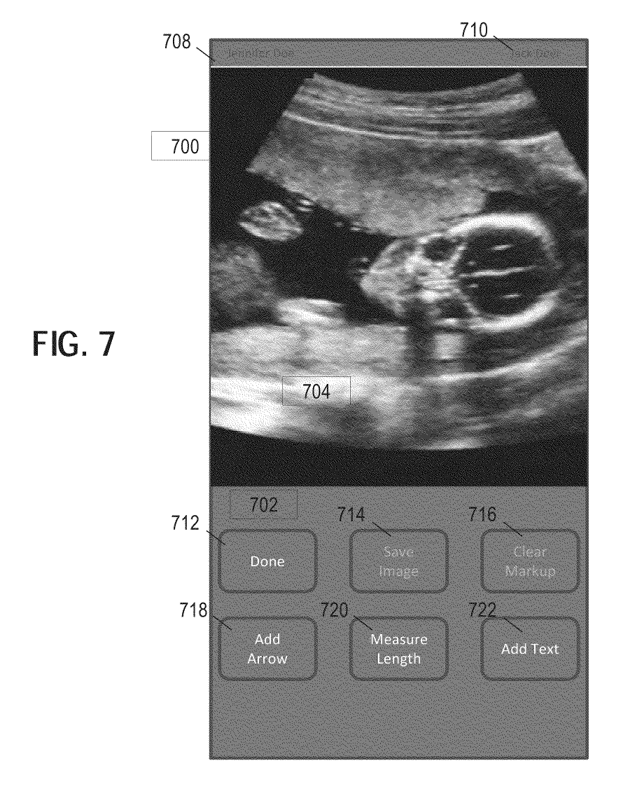

FIG. 7 illustrates a screen display of a mobile computing device that is configured to enable initiating performing precise measurements of objects shown in an image.

In an embodiment, a mobile device screen 700 comprises an image region 704 and a button region 702. In an embodiment, screen 700 further comprises a patient identifier 708 and an operator identifier 710. The patient identifier 708 comprises a name of a patient who is associated with an image in the image region 704. The operator identifier 710 identifies a name of an operator who is operating the mobile device.

In an embodiment, image region 704 displays an image of an anatomical structure that has been captured during an image scanning operation or loaded from computer memory or loaded from networked computer storage. The subject image may be a static image, a frozen frame of a scan in progress, or a frame of a previously stored moving image or cine file. Thus, embodiments herein may be used during an exam or protocol; for example, an operator may have performed a real time scan of a patient to capture a series of images, and then selected a Freeze button or other operation to cause static display of a particular image in the image region 704 for annotation or markup. Alternatively, an embodiment may involve retrieving a previously stored image from device storage, or attached storage, or networked storage, and then performing markup or annotation of the retrieved, displayed image.

In an embodiment, image region 704 further comprises measurement data 706 that identifies measurement attributes such as depth of an anatomical structure or a length of a measured structure.

In an embodiment, button region 702 comprises a Done button 712, Save Image button 714, Clear Markup button 716, Add Arrow button 718, Measure Length button 720, and Add Text button 722. In an embodiment, selection of a particular button in the button region 702 causes the mobile device to perform one or more operational functions as further described herein. In an embodiment, the operational functions include performing annotation or markup of an image by adding identifying arrows, measuring the length of structures and applying length labels or indicators, or adding text labels to the image. These functions may be performed in various ways in various embodiments and the following description provides an example of one way of performing the measurement function.

In an embodiment, playing a stored moving image such as a cine file and then selecting buttons 718, 720, or 722 causes the mobile device to create a new file consisting of the then-currently displayed image frame from the cine file, and add markup elements to the new file.

In an embodiment, selecting the Done button 712 signals that the operator has completed performing markup functions. In response, the mobile device changes the button region 702 to display different function buttons associated with a different operational mode or operational function.

In an embodiment, selecting the Save Image button 714 causes the mobile device to save the currently displayed graphical image of image region 704 in persistent storage of the mobile device, attached storage, or networked storage. In an embodiment, if no changes have been made to the displayed image of image region 704 in the form of adding arrows, length measurements, or text labels, then the Save Image button 714 is displayed in a grayed out form to suggest to the operator that the function is unavailable. If the Save Image button is available and is selected, then in response metadata representing positions of one or more reticles 816, 820, which are further described below, is saved in association with the image in storage of the mobile device, in attached storage, or in networked storage. When the same image is reloaded into the image region 104, the stored metadata is obtained and interpreted, and any reticles or measurement lines in the image are displayed over the image. In an embodiment, the Save Image button 714 causes saving the image as a BSX file with the markup information present as metadata in the file, and as a JPG file with the metadata overwritten on the image.

In an embodiment, selecting the Clear Markup button 716 signals that the operator wishes to remove any arrows, length measurements, or text labels that have been added to the image of the image region 704 since the last Save Image operation. In an embodiment, if no changes have been made to the displayed image of image region 704 in the form of adding arrows, length measurements, or text labels since the image was scanned or loaded, then the Clear Markup button 716 is displayed in a grayed out form to suggest to the operator that the function is unavailable.

In various embodiments, the button region 702 may include other buttons associated with adding other types of measurements, such as measuring an elliptical region of the image, measuring a polygon region of the image, etc.

In an embodiment, selecting the Add Arrow button 718 or the Add Text button 722 signals that the operator wishes to add a graphical arrow pointing to a particular part of the image in the image region 704, or add a text label for a particular part of the image, respectively. In response, the mobile device displays positioning tools or text entry tools associated with placing a graphical arrow or a text label to appear over the image. The particular processes, images and icons associated with adding arrows and text labels are not essential to the present disclosure.

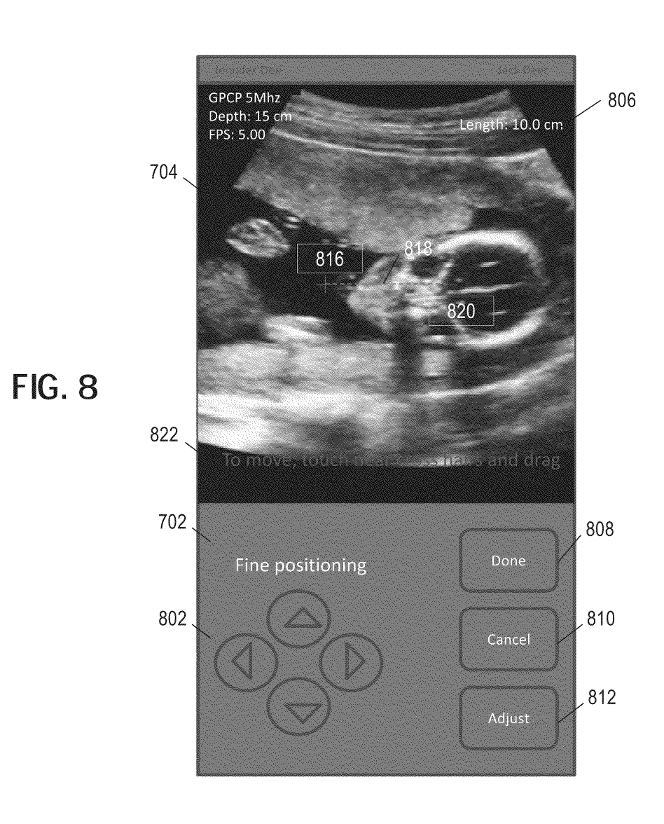

In an embodiment, selecting the Measure Length button 720 indicates that the operator wishes to measure a length of a particular part, such as an anatomical structure, shown in the image of image region 704. In an embodiment, in response to selection of the Measure length button 720, the mobile device changes the button region 702 and image region 704 to a new measurement configuration as shown in FIG. 8, for example.

FIG. 8 further illustrates a screen display of a mobile computing device that is configured to enable initiating performing precise measurements of objects shown in an image.

In an embodiment, button region 702 comprises fine positioning controls 802, a Done button 808, a Cancel button 810, and an Adjust button 812. In an embodiment, first and second reticles 816, 820 are displayed over the image in image region 704, and a measurement line 818 is displayed between the reticles. A length indicator 806 is displayed over the image and specifies a linear measurement between the reticles 816, 820 as represented by the then-currently displayed measurement line 818. In an embodiment, the magnitude indicated by length indicator 806 may be displayed to a specified degree of precision, e.g., 8 digits of precision as indicated in the example value of 10.0 cm.

For purposes of illustrating a clear example, the description in this section relates to positioning first and second reticles that are connected by a line indicating a linear measurement. However, embodiments are not limited to two (2) reticles and the techniques described herein may be used for positioning a single reticle on an image in a precise manner, or for positioning vertex points of polygons, the foci or perimeter-defining points of ellipses or circles, or other shapes. For example, even when linear measurement is performed, shapes surrounding or relating to the linear measurement may be different. For example, two (2) points may represent the diameter of a circle and not just a straight line; three (3) points may represent loci for an oval or ellipse; four (4) points may represent a polygon.

For purposes of illustrating a clear example, the drawings relating to this section illustrate reticles as crosshairs. However, for purposes of this disclosure, the term “reticle” broadly includes a point, symbol, text, shape, arrow, or other graphical indicator.

For purposes of illustrating a clear example, the drawings and description relating to this section illustrate positioning reticles on an ultrasound scan image. However, for purposes of this disclosure, the term “image” as used herein refers to any kind of graphical image and is not limited to ultrasound scan images. For example, any of the techniques described herein may be used for positioning on digital photos, or other graphical images that have been created or obtained using means other than a camera or ultrasound scanner.

In an embodiment, the reticles 816, 820 are initially displayed in a default position over the image of image region 704; for example, the reticles may be displayed generally in a center of the image. In an embodiment, measurement line 818 is initially displayed in a default length and orientation. For example, the reticles 816, 820 may be spaced apart and aligned so that the measurement line 818 is initially displayed in a horizontal position and has a scaled length of about 10 cm. In other embodiments, initial display of the reticles and measurement line may occur in other positions or orientations.

In an embodiment, one of the reticles 816, 820 is initially designated as a default selected reticle and is displayed in a distinctive color. Subsequent positioning and movement operations are applied to the default selected reticle, unless the operator selects another reticle by tapping the screen near the desired reticle.

In an embodiment, a hint message 822 is initially displayed over the image in image region 714 in response to the operator selecting the Measure Length button 720 of FIG. 7. In an embodiment, the hint message 822 states: “To move, touch near cross hair and drag”. In an embodiment, the hint message is displayed for a specified time period, for example, two seconds, and then is removed from the image or fades from the image.

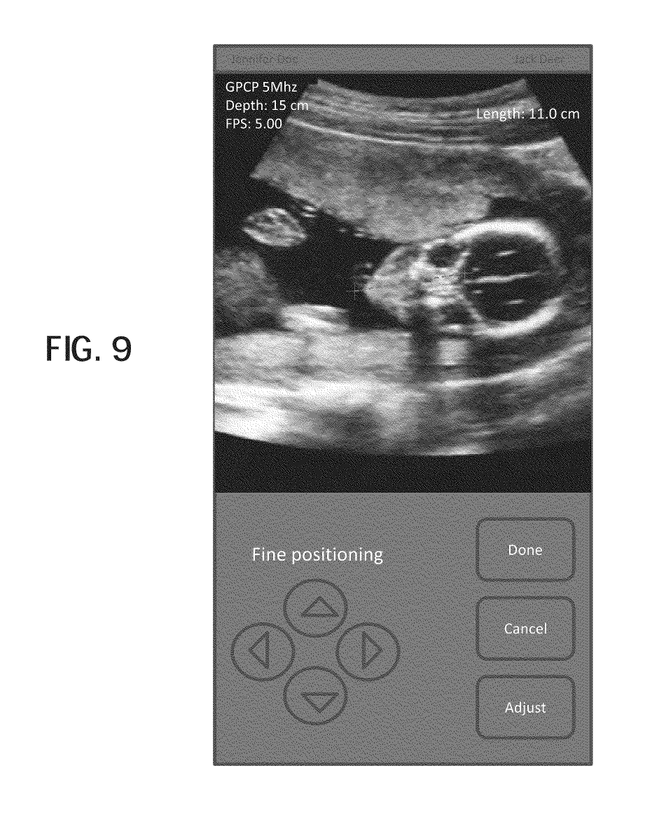

In an embodiment, an operator touching the touch-sensitive screen of computer 400 in image region 704 near to one of the reticles 816, 820 and performing a dragging gesture on the image region 704 causes the mobile device to select that particular one of the reticles 816, 820 that is closest to the touched point in the image region, and to re-display that one of the reticles 816, 820 in a new position corresponding to the magnitude and direction of the dragging. For example, the operator may touch the image region 704 at any point that is closer to the left reticle 816 than to the right reticle 820 and then drag the operator's finger across the screen to position that reticle, resulting in the modified screen display illustrated in FIG. 9. In an embodiment, touching the image region 704 at a point nearer to one reticle than the other causes the mobile device to designate the nearest reticle as the selected reticle and to redisplay the selected reticle in a distinctive color.

The use of a distinctive color for a selected reticle is not required in all embodiments and various particular colors may be used. In an ultrasound scanning application, image may have high contrast white elements and the particular color may be selected to be visible when displayed over bright white. Example colors include red and orange. In some embodiments, particular markup elements may be displayed in a first particular color and other markup elements may be displayed in a second particular color. For example, in one embodiment, a selected reticle is displayed in red and the other reticle and the measurement line are displayed in orange.

In an embodiment, if the operator has loaded an image that contains one or more stored markup elements, such as previously created sets of reticles and measurement lines, the previously created reticles are not available for selection and only reticles that are newly created in the current session can be selected. Thus, touching the image region 704 near a previously created reticle, and also near a new reticle that was placed in the image in response to the operator selecting Measure Length button 720, is interpreted by the mobile device as an unambiguous selection of only the new reticle.

In an embodiment, logic in the mobile device prohibits an operator from selecting one of the reticles 816, 820 and dragging the selected reticle to a position over the other, non-selected reticle. In an embodiment, in response to detecting that the operator is dragging one reticle to a position that overlaps or is too close to the other one of the reticles, the mobile device displays an error message and returns the dragged reticle to its position before the dragging operation began. In an embodiment, the error message states: “Cross hairs cannot be made to overlap”.

Further, as seen in FIG. 9, the length indicator 806 is updated promptly in response to a dragging operation to reflect a new length of the measurement line 818. In the example of FIG. 9, the length indicator 806 has been updated from the value 10.0 cm to the new value 11.0 cm. Touching, dragging, and redisplaying a reticle 816, 820 and the length indicator 806 may occur repeatedly according to the needs of the operator.

In an embodiment, selecting a particular one of the fine positioning controls 802, such as Left control 804, causes the mobile device to move the last selected or touched one of the reticles 816, 820 laterally to the left by a small amount. Selecting may comprise touching and holding the particular one of the fine positioning controls 802. The magnitude of the small amount is configurable and may be, for example, 1 mm or some other amount that is difficult to achieve by dragging a reticle 816, 820 using a human finger.

In an embodiment, selecting one of the fine positioning controls 802 by tapping the control causes the then-currently selected one of the reticles 816, 820 to move in the direction indicated by the particular fine positioning control by one screen pixel.

The operator may touch or tap any of the fine positioning controls 802 to cause moving and redisplaying the last selected reticle by a small amount in a direction that is graphically depicted by the form of the fine positioning controls. For example, fine positioning controls 802 may be associated with the four compass directions north, south, east, west or with similar directions left, right, up, down, etc., or with other directions or methods of adjustment.

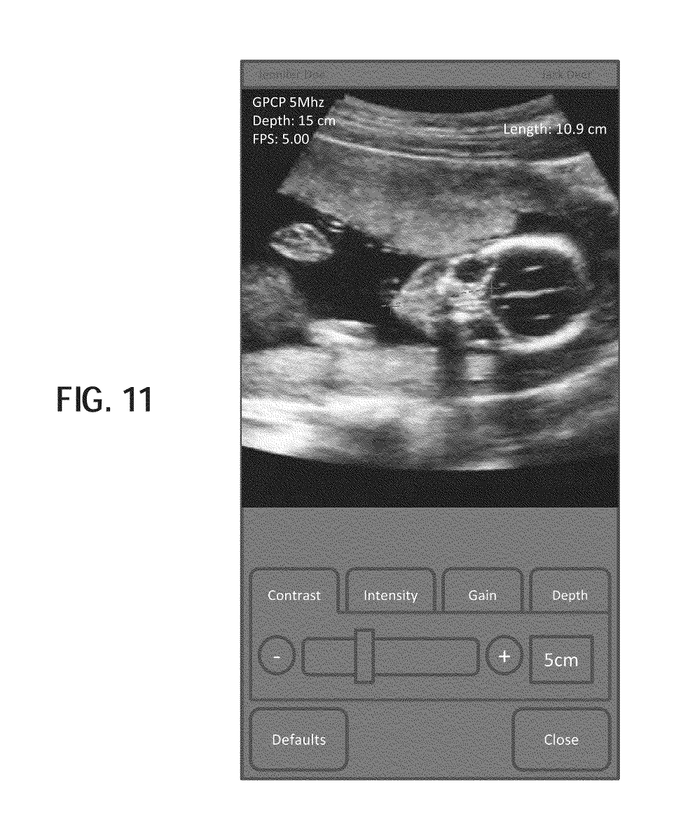

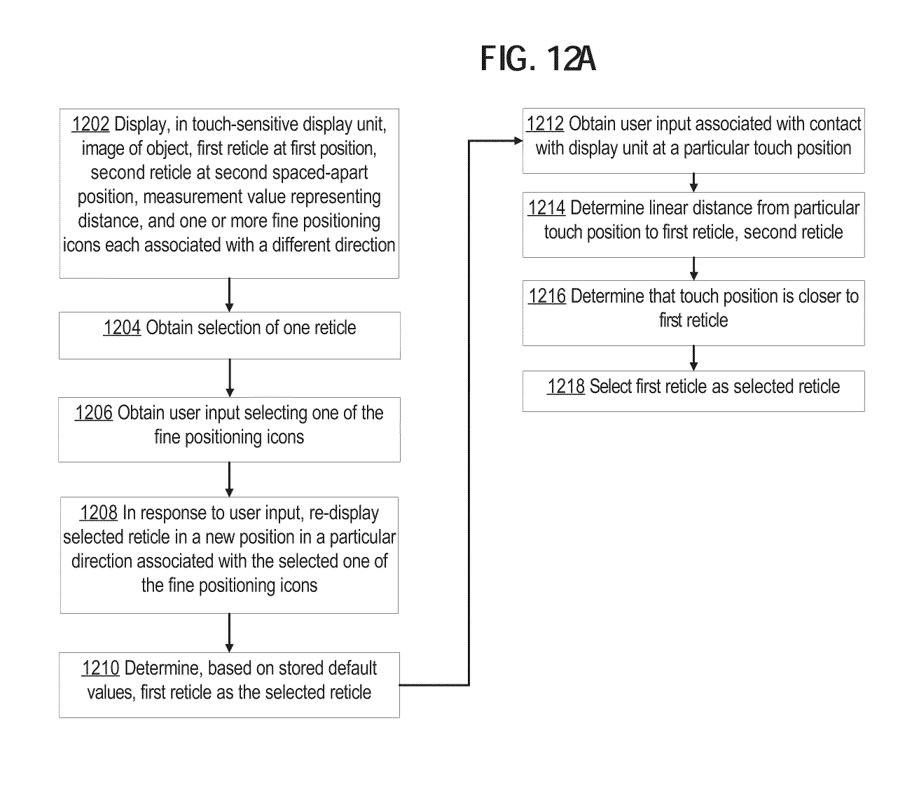

In an embodiment, selecting the Adjust button 812 causes the mobile device to display facilities in the button region 702 that enable the operator to modify one or more image gain, contrast, intensity and depth (GCID) parameters associated with the image in the image region 704. Adjustment of the GCID parameters through use of the Adjust button 812 may enable the operator to see part of the image more clearly while positioning the reticles 816, 820. FIG. 11 illustrates a computer screen display configured with controls to permit adjustment of GCID parameters.

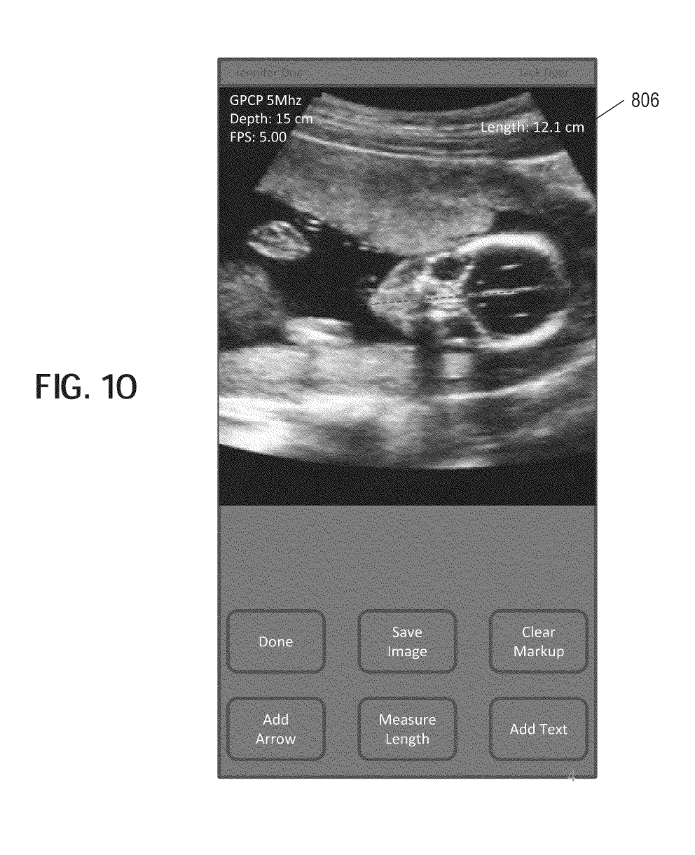

In an embodiment, selecting the Done button 808 signals that the operator has completed positioning the measurement reticles 816, 820 and measurement line 818. In response, the mobile device returns the screen display to the form shown in FIG. 7 or FIG. 10. FIG. 10 illustrates a screen display showing the image of FIG. 9 after further adjustments and after an operator has selected the Done button, returning to the previous screen state in which the buttons of FIG. 7 are available. FIG. 10 represents a case in which additional changes were made using touch gestures, such that the positions of the reticles is different and the length indicator 806 has been updated. When interacting with the screen display of FIG. 10, the operator can select the Save Image button 714 to cause storing the image and metadata associated with newly added reticles 816, 820 and measurement line 818.

After applying a measurement line markup in the manner previously described and saving the markup using the Done button 808 and Save Image button 714, the user may again select any of the Add Arrow button 718, Measure Length button 720, and Add Text button 72 to add another arrow, length measurement, or text label to the image. Thus the operator may build up successive conceptual layers of markup on the image through a series of individual markup, completion and saving operations. In an embodiment, the mobile device may permit only a specified maximum number of markup elements or layers, such as four pairs of reticles. Other embodiments may permit other specified maximum numbers of markup elements, based on the image file format that is used and the number or size of metadata values that may be stored in connection with a particular image or file format.

Alternatively, the operator could select the Clear Markup button 716 to clear the reticles and measurement line from the image. In an embodiment, selecting the Done button 808 causes metadata values associated with positions of the reticles 816, 820 to be stored in memory. In various embodiments, the mobile device may prohibit editing positions of the reticles after the Done button 808 is selected, or may provide an editing function.

In an embodiment, selecting the Cancel button 810 acts as a request to discard any measurement line that has been added, or changes to a measurement line, and causes the mobile device to terminate line measurement operations in the current session. Other embodiments may comprise logic that enables an operator to undo one or more successive changes to the positions of the reticles 816, 820 and the measurement line 818.

In an embodiment, in response to a selection of the Cancel button 810, the mobile device redisplays the screen in the form shown in FIG. 7 or displays other function operation buttons. In an embodiment, if changes in the position of the reticles 816, 820 and measurement line 818 have been made, the mobile device prompts the operator about whether to save the changes in metadata associated with the image. If the operator provides a negative response then the changes are lost and otherwise the changes may be saved. If changes in the current session are lost but the image already had reticle data and measurement line data stored in association with the image, that data is unchanged and the measurement line will be displayed when the same image is reloaded in the future. Thus, selecting the Cancel button 810 is effective to cancel only changes that were made in the current session since the last time that the image was saved.

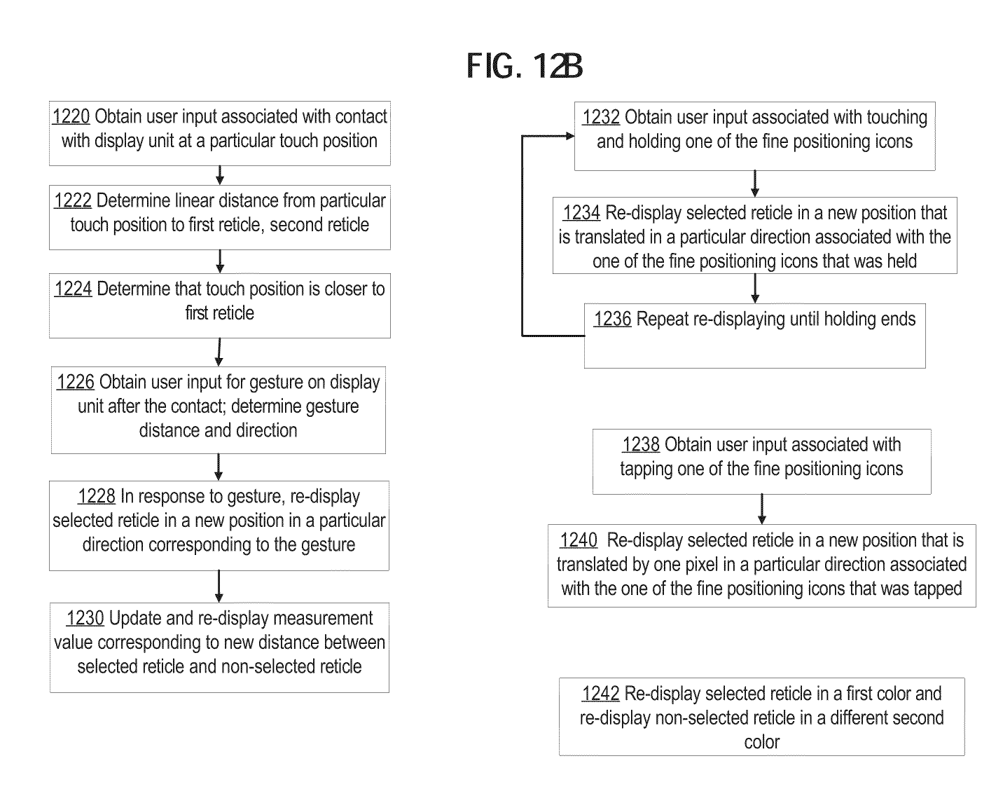

FIG. 12A, FIG. 12B illustrate methods of precise measurement using a computer. Referring first to FIG. 12A, step 1202 comprises displaying, in a touch-sensitive computer display unit, an image of an object; over the image, a first reticle at a first position and a second reticle at a second position that is spaced apart from the first position; a measurement value representing a linear distance between the first reticle and the second reticle with reference to the object; and one or more fine positioning icons each associated with a different direction. Step 1204 comprises obtaining a selection of one of the first reticle and the second reticle as a selected reticle. Step 1206 comprises obtaining user input selecting one of the fine positioning icons. Step 1208 comprises, in response to the user input, re-displaying the selected reticle in a new position in a particular direction associated with the selected one of the fine positioning icons.

Step 1210 illustrates determining, based on stored default reticle values and without user input, the first reticle as the selected reticle by default.

Step 1212 comprises obtaining user input associated with contact with the display unit at a particular touch position. Step 1214 comprises determining a linear distance from the particular touch position to the first reticle and the second reticle. Step 1216 comprises determining that the particular touch position is closer to the first reticle than the second reticle. Step 1218 comprises in response, selecting the first reticle as the selected reticle.

Referring now to FIG. 12B, step 1220 comprises obtaining user input associated with contact with the display unit at a particular touch position. Step 1222 comprises determining a linear distance from the particular touch position to the first reticle and the second reticle. Step 1224 comprises determining that the particular touch position is closer to the first reticle than the second reticle and in response, selecting the first reticle as the selected reticle. Step 1226 comprises obtaining user input associated with a gesture on the display unit after the contact and determining a gesture distance and gesture direction of the gesture. Step 1228 comprises, in response to the gesture, re-displaying the selected reticle in a new position in a particular direction corresponding to the gesture distance and gesture direction. The gesture may comprise dragging.

Step 1230 comprises updating and redisplaying the measurement value corresponding to a new distance between the new position of the selected reticle and a non-selected one of the first reticle and the second reticle. Steps 1220-1230 represent a sub-process that can be performed at any appropriate time while a user is viewing or marking up an image, in response to touch input.

Step 1232 comprises obtaining user input associated with touching and holding one of the fine positioning icons. Step 1234 comprises re-displaying the selected reticle in a new position that is translated in a particular direction associated with the selected one of the fine positioning icons that is held. Step 1236 comprises repeating the re-displaying until determining that the holding ends. Steps 1232-1236 represent a sub-process that can be performed at any appropriate time while a user is viewing or marking up an image, in response to touch input.

Step 1238 comprises obtaining user input associated with tapping one of the fine positioning icons. Step 1240 comprises, in response to the user input, re-displaying the selected reticle in a new position that is translated by one pixel in a particular direction associated with the selected one of the fine positioning icons that is held. Steps 1238-1240 represent a sub-process that can be performed at any appropriate time while a user is viewing or marking up an image, in response to touch input.

Step 1242 comprises re-displaying the selected reticle in a first color and re-displaying a non-selected one of the first reticle and the second reticle in a second color that is different than the first color. Redisplaying in different colors may be performed as part of any of the sub-processes described above.

In various steps, one or more of the first reticle and the second reticle is a crosshair, a point, symbol, text, shape, arrow, or other graphical indicator. In various steps, the computer is a handheld computer coupled to an ultrasound sensor.

### Hardware Overview

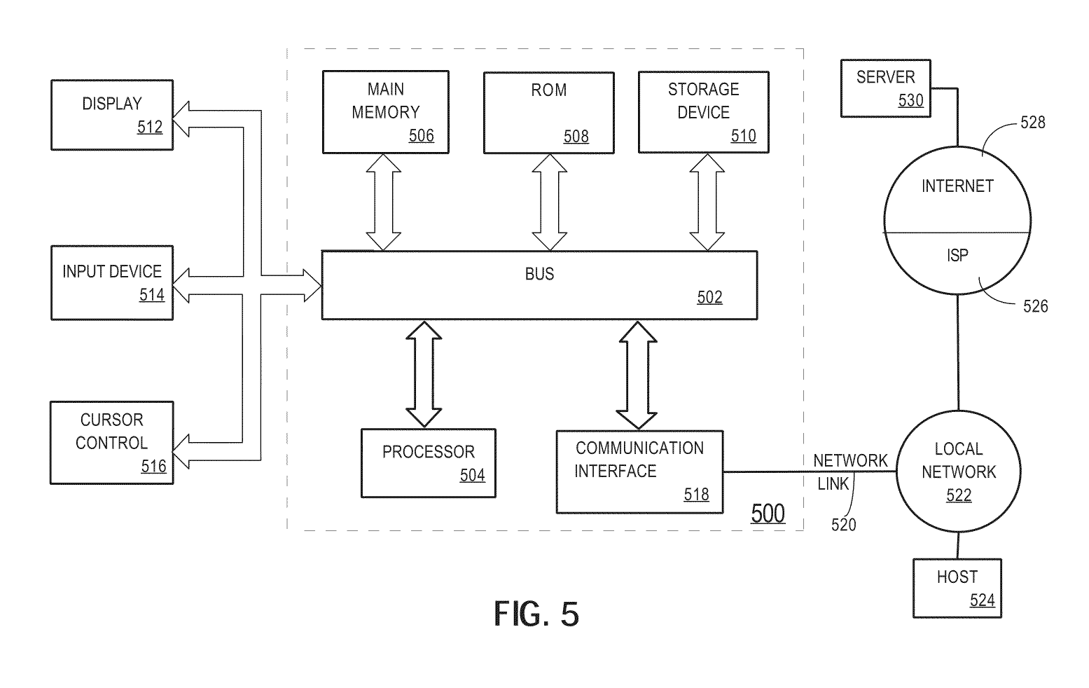

FIG. 5 is a block diagram that illustrates a computer system 500 upon which an embodiment may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments are not limited to any specific combination of hardware circuitry and software.

The term “machine-readable medium” as used herein refers to any medium that participates in providing data that causes a machine to operation in a specific fashion. In an embodiment implemented using computer system 500, various machine-readable media are involved, for example, in providing instructions to processor 504 for execution. Such a medium may take many forms, including but not limited to storage media and transmission media. Storage media includes both non-volatile media and volatile media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

In the foregoing specification, embodiments have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A computer comprising:
one or more processors;
a computer readable storage medium comprising a sequence of instructions, which when executed by the one or more processors, cause the one or more processors to perform:
displaying, on a touch-sensitive computer display unit:
an image of an object;
over the image, a first reticle at a first position and at least a second reticle at a second position that is spaced apart from the first position;
a measurement value representing a linear distance between the first reticle and the second reticle with reference to the object;
one or more fine positioning icons each associated with a different direction;
obtaining a selection of one of the first reticle and the second reticle as a selected reticle;
obtaining user input selecting one of the fine positioning icons;
in response to the user input, re-displaying the selected reticle in a new position in a particular direction associated with the selected one of the fine positioning icons.

2. The computer of claim 1 wherein the instructions that cause obtaining a selection of the first reticle or the second reticle as a selected reticle comprise instructions that cause determining, based on stored default reticle values and without user input, the first reticle as the selected reticle by default.

3. The computer of claim 1 further comprising instructions that cause obtaining user input associated with contact with the display unit at a particular touch position, determining a linear distance from the particular touch position to the first reticle and the second reticle, determining that the particular touch position is closer to the first reticle than the second reticle, and in response, selecting the first reticle as the selected reticle.

4. The computer of claim 1 further comprising instructions which when executed cause:
obtaining user input associated with contact with the display unit at a particular touch position;
determining a linear distance from the particular touch position to the first reticle and the second reticle;
determining that the particular touch position is closer to the first reticle than the second reticle and in response, selecting the first reticle as the selected reticle;
obtaining user input associated with a gesture on the display unit after the contact and determining a gesture distance and gesture direction of the gesture;
in response to the gesture, re-displaying the selected reticle in a new position in a particular direction corresponding to the gesture distance and gesture direction.

5. The computer of claim 4 wherein the gesture comprises dragging.

6. The computer of claim 4, further comprising instructions which when executed cause updating and redisplaying the measurement value corresponding to a new distance between the new position of the selected reticle and a non-selected one of the first reticle and the second reticle.

7. The computer of claim 1, further comprising instructions which when executed cause obtaining user input associated with touching and holding one of the fine positioning icons; in response to the user input, re-displaying the selected reticle in a new position that is translated in a particular direction associated with the selected one of the fine positioning icons that is held; repeating the re-displaying until determining that the holding ends.

8. The computer of claim 1, further comprising instructions which when executed cause obtaining user input associated with tapping one of the fine positioning icons; in response to the user input, re-displaying the selected reticle in a new position that is translated by one pixel in a particular direction associated with the selected one of the fine positioning icons that is held.

9. The computer of claim 1 further comprising instructions which when executed cause re-displaying the selected reticle in a first color and re-displaying a non-selected one of the first reticle and the second reticle in a second color that is different than the first color.

10. The computer of claim 1 further comprising instructions which when executed cause displaying the one or more fine positioning icons only in response to obtaining user input selecting an image manipulation function.

11. The computer of claim 1 wherein one or more of the first reticle and the second reticle is a crosshair.

12. The computer of claim 1 comprising a handheld computer coupled to an ultrasound sensor.

13. The computer of claim 1 wherein the first reticle and second reticle are associated with any of: endpoints of the measurement line; a diameter of a circle; vertices of a polygon; or loci of an oval or ellipse.

14. The computer of claim 1, wherein the image is an ultrasound scan image.

15. A data processing method comprising:
displaying, on a touch-sensitive computer display unit:
an image of an object;
over the image, a first reticle at a first position and a second reticle at a second position that is spaced apart from the first position;
a measurement value representing a linear distance between the first reticle and the second reticle with reference to the object;
one or more fine positioning icons each associated with a different direction;
obtaining a selection of one of the first reticle and the second reticle as a selected reticle;
obtaining user input selecting one of the fine positioning icons;
in response to the user input, re-displaying the selected reticle in a new position in a particular direction associated with the selected one of the fine positioning icons.

16. The method of claim 15 further comprising determining, based on stored default reticle values and without user input, the first reticle as the selected reticle by default.

17. The method of claim 15 further comprising obtaining user input associated with contact with the display unit at a particular touch position, determining a linear distance from the particular touch position to the first reticle and the second reticle, determining that the particular touch position is closer to the first reticle than the second reticle, and in response, selecting the first reticle as the selected reticle.

18. The method of claim 15 further comprising:
obtaining user input associated with contact with the display unit at a particular touch position;
determining a linear distance from the particular touch position to the first reticle and the second reticle;
determining that the particular touch position is closer to the first reticle than the second reticle and in response, selecting the first reticle as the selected reticle;
obtaining user input associated with a gesture on the display unit after the contact and determining a gesture distance and gesture direction of the gesture;
in response to the gesture, re-displaying the selected reticle in a new position in a particular direction corresponding to the gesture distance and gesture direction.

19. The method of claim 15 wherein the gesture comprises dragging.

20. The method of claim 15 further comprising, further comprising updating and redisplaying the measurement value corresponding to a new distance between the new position of the selected reticle and a non-selected one of the first reticle and the second reticle.

21. The method of claim 15 further comprising obtaining user input associated with touching and holding one of the fine positioning icons; in response to the user input, re-displaying the selected reticle in a new position that is translated in a particular direction associated with the selected one of the fine positioning icons that is held; repeating the re-displaying until determining that the holding ends.

22. The method of claim 15 further comprising obtaining user input associated with tapping one of the fine positioning icons; in response to the user input, re-displaying the selected reticle in a new position that is translated by one pixel in a particular direction associated with the selected one of the fine positioning icons that is held.

23. The method of claim 15 further comprising re-displaying the selected reticle in a first color and re-displaying a non-selected one of the first reticle and the second reticle in a second color that is different than the first color.

24. The method of claim 15 further comprising displaying the one or more fine positioning icons only in response to obtaining user input selecting an image manipulation function.

25. The method of claim 15 wherein one or more of the first reticle and the second reticle is a crosshair.

26. The method of claim 15 wherein the image is an ultrasound scan image.

27. The method of claim 15 wherein the first reticle and second reticle are associated with any of: endpoints of the measurement line; a diameter of a circle; vertices of a polygon; or loci of an oval or ellipse.

28. A computer comprising:
one or more processors;
a computer readable storage medium comprising a sequence of instructions, which when executed by the one or more processors, cause the one or more processors to perform:
displaying, on a touch-sensitive computer display unit:
an image of an object;
over the image, a reticle at a first position;
one or more fine positioning icons each associated with a different direction;
obtaining user input selecting one of the fine positioning icons;
in response to the user input, re-displaying the reticle in a new position in a particular direction associated with the selected one of the fine positioning icons.

28. The computer of claim 28 further comprising instructions which when executed cause:
obtaining user input associated with contact with the display unit at a particular touch position;
obtaining user input associated with a gesture on the display unit after the contact and determining a gesture distance and gesture direction of the gesture;
in response to the gesture, re-displaying the reticle in a new position in a particular direction corresponding to the gesture distance and gesture direction.

29. The computer of claim 28, further comprising instructions which when executed cause obtaining user input associated with touching and holding one of the fine positioning icons; in response to the user input, re-displaying the reticle in a new position that is translated in a particular direction associated with the selected one of the fine positioning icons that is held; repeating the re-displaying until determining that the holding ends.

30. The computer of claim 28, further comprising instructions which when executed cause obtaining user input associated with tapping one of the fine positioning icons; in response to the user input, re-displaying the reticle in a new position that is translated by one pixel in a particular direction associated with the selected one of the fine positioning icons that is held.

31. The computer of claim 28 comprising a handheld computer coupled to an ultrasound sensor.

32. The computer of claim 28 wherein the image is an ultrasound scan image.

33. The computer of claim 28 wherein the reticle is a crosshair.

34. The computer of claim 28 wherein the reticle is associated with any of: an endpoint of a measurement line; a diameter of a circle; a vertex of a polygon; or a locus of an oval or ellipse.

35. A data processing method comprising:
displaying, on a touch-sensitive computer display unit:
an image of an object;
over the image, a reticle at a first position;
one or more fine positioning icons each associated with a different direction;
obtaining user input selecting one of the fine positioning icons;
in response to the user input, re-displaying the reticle in a new position in a particular direction associated with the selected one of the fine positioning icons.

36. The method of claim 35 further comprising:
obtaining user input associated with contact with the display unit at a particular touch position;
obtaining user input associated with a gesture on the display unit after the contact and determining a gesture distance and gesture direction of the gesture;
in response to the gesture, re-displaying the reticle in a new position in a particular direction corresponding to the gesture distance and gesture direction.

37. The method of claim 35, further comprising obtaining user input associated with touching and holding one of the fine positioning icons; in response to the user input, re-displaying the reticle in a new position that is translated in a particular direction associated with the selected one of the fine positioning icons that is held; repeating the re-displaying until determining that the holding ends.

38. The method of claim 35, further comprising obtaining user input associated with tapping one of the fine positioning icons; in response to the user input, re-displaying the reticle in a new position that is translated by one pixel in a particular direction associated with the selected one of the fine positioning icons that is held.

39. The method of claim 35 wherein the image is an ultrasound scan image.

40. The method of claim 35 wherein the reticle is a crosshair.

41. The method of claim 35 wherein the reticle is associated with any of: an endpoint of a measurement line; a diameter of a circle; a vertex of a polygon; or a locus of an oval or ellipse.
